(19) United States
(12) Patent Application Publication
(10) Pub. No.: US 2019/0164357 A1
(43) Pub. Date: May 30, 2019

(54) MEANS FOR DETERMINING TOLL DATA

(71) Applicant: JAGUAR LAND ROVER LIMITED, Coventry (GB)

(72) Inventor: BINU JOHN, Warwickshire (GB)

(21) Appl. No.: 16/203,014

(22) Filed: Nov. 28, 2018

(30) Foreign Application Priority Data
Nov. 30, 2017 (IN) 201711043020
Jan. 15, 2018 (GB) 1800604.9

(51) Int. Cl. G07B 15/06; G06Q 20/28; G01C 21/36

(52) U.S. Cl. CPC G07B 15/063; G06Q 2240/00; G01C 21/3658; G06Q 20/28

(57) ABSTRACT

Determining toll data can include receiving a first data set, wherein the first data set corresponds to one or more toll stations, and receiving a second data set indicating either or both lane and traffic information associated with at least one of the toll stations, the first data set being processed to determine at least one payment option associated with the one or more toll stations, wherein the at least one payment option is output to a human machine interface for selection by a user of a vehicle. A toll station lane of a first toll station can be allocated based on the second data set. The allocated toll station lane can be output to a human machine interface to guide the user.

### CROSS REFERENCE TO RELATED APPLICATIONS

This application claims priority to and the benefit of Great Britain Patent Application No. 1800604.9 filed Jan. 15, 2018, and India Patent Application No. 201711043020 filed Nov. 30, 2017, which are incorporated by reference herein in their entirety.

### TECHNICAL FIELD

The present disclosure relates to a means for determining toll data. Particularly, but not exclusively, the disclosure relates to means for determining one or more fee options relating to one or more toll stations, and displaying said fee options to a user. Aspects of the invention relate to a controller for determining toll data, to a system for determining toll data, to a method for determining toll data, to a computer readable medium and to a vehicle.

### BACKGROUND

There is a desire to improve the ways in which fees associated with toll stations may be displayed to the driver or an occupant of the vehicle, and then subsequently paid upon approach to a toll station.

A toll road is a road for which a fee is required for passage, typically calculated based on the class of vehicle passing through. In many cases, the vehicle class is determined by various aspects such as vehicle type, weight or number of axles. As such, a motorcycle or car will usually be charged at a lower rate than a van or lorry.

Toll fees are collected at collection points commonly known as toll stations, toll gates, toll booths and the like. Previously, toll stations would be formed of multiple payment points, either manned or unmanned, configured to allow the driver or an occupant of the vehicle to manually pay the toll fee with cash or an electronic payment card as they pass through. However, it is becoming increasingly common for toll stations to provide automated toll payment in which the driver or a user of the vehicle may pay the toll fee using an associated account, wherein the fee is automatically deducted from the account when the vehicle passes through the toll station. In some known systems, the vehicle is fitted with a radio frequency (RF) transponder that communicates with an antenna at the toll station. The antenna detects the transponder's unique signal when the vehicle approaches the barrier, which is then used to calculate and deduct the fee. In other systems, the toll station uses camera technology for automatic number plate recognition.

However, in such systems, the toll fee is automatically deducted without providing the driver or occupant with any indication of how much the toll fee is, or any alternative payment options. For example, the driver or occupant is not provided with the option to pay a single toll fee for passing through the toll station once, the fee for a return trip both ways through the toll station, or the fee for crossing the toll station several times a day or month. For vehicles that pass through multiple toll stations during each journey or day, this can be particularly problematic as it requires them to ensure that there are sufficient funds in their account before the beginning of every journey.

Furthermore, most toll stations comprise a number of different payment points, including automatic and manual payment points, which requires drivers of vehicles to know which lane they need to be in in order to pay the toll fee in their chosen way. This can prove to be quite a large distraction to the driver as they approach the toll station, which is particularly undesirable during busy and congested periods, and especially if driving alone.

Accordingly, there is a desire to improve the ways in which a driver or an occupant can view and select toll fees, in particular by displaying information relating to the toll station to the driver or occupant before they reach the toll station.

### SUMMARY

Aspects and embodiments of the invention provide a controller, a system, a method, a computer readable medium and a vehicle as claimed in the appended claims.

According to an aspect of the invention, there is provided a controller for determining toll data, the controller being arranged to: receive a first data set, wherein the first data set corresponds to one or more toll stations; receive a second data set indicating lane and/or traffic information associated with at least one of the toll stations; process the first data set to determine at least one payment option associated with the one or more toll stations; output the at least one payment option to a human machine interface for selection by a user of a vehicle; allocate a toll station lane of a first toll station, in dependence on the second data set; and output the allocated toll station lane to a human machine interface, to guide the user.

The human machine interfaces may comprise one or more displays.

In various aspects, the vehicle is non-autonomous or is in a non-autonomous driving mode when the allocated toll station lane is output to the human machine interface to guide the user.

The toll station lane may be allocated in dependence on one or more of: a user-selected method of payment associated with a subset of lanes; lane closure information associated with a subset of lanes; a class of the vehicle; an occupancy of the vehicle; or traffic in one or more lanes relative to one or more other lanes. This reduces toll station queues and journey times. For example, if the driver or occupant intends to pay manually, a user will be guided to a specific manual payment lane that is open and has a lower level of congestion than another open manual payment lane, before the toll station, booth or gate is reached.

The first data set may be dependent on a route of the vehicle and/or traffic sign recognition and/or vehicle-to-vehicle communication and/or infrastructure-to-vehicle communication.

As such, on approach to a toll station, at least one fee payable for crossing that toll station is automatically displayed to a user of a vehicle, for example, a driver or occupant user of the vehicle. To achieve this, the controller receives data relating to the toll stations located along the route of the vehicle, for example, toll stations located along a specified route that the vehicle is taking, or toll stations that are located on a road that the vehicle is travelling along, or is soon to be travelling along. In this respect, the route may be a route calculated by a navigation system based on a geographical location or destination input by a user, with data relating to tolls stations located along this route being used to determine the at least one payment options. Alternatively, the route may be a predicted route based on the vehicle's location and map data corresponding to that location. For example, the vehicle may be driving along a road that has no exits before one or more toll stations, and so data relating to the toll stations before the next exit is used to determine the at least one payment option. Alternatively, the route may be a predicted route based on other user data and/or journey history, with data relating to toll stations located along these predicted routes being used to determine the at least one payment option. For example, the user may frequently take the same route at a certain time on a particular day. As another example, the user may have previously taken a route that will require a return trip. As a further example, the user data may include calendar data showing meetings, appointments and the like. The location of these meetings or appointments may then be used to predict a route that the user will take.

The toll station data is then used to calculate at least one fee for the approaching toll station(s) and display it to the driver or occupant user of the vehicle. In doing this, the user is able to see what fee(s) are due before they reach the toll station, and before any money is taken from an associated account.

Optionally, the controller may be configured to determine a plurality of payment options associated with the one or more toll stations, and output the plurality of payment options to the display for selection by the user. For example, the controller may determine the fees for a single trip or a return trip through one toll station, or the collective fee for passing through two or more toll stations. An advantage of enabling multiple advance fee payments in a single transaction is reducing a number of user inputs and reducing queuing at toll stations.

It will be appreciated that the controller may comprise any suitable means for performing the above functions, for example, the controller may comprise one or more input means configured to receive the first data set, a processor configured to determine the at least one payment option, and one or more output means configured to output the at least one payment option. Optionally, the controller may also comprise a memory for storing the received and determined data.

In embodiments, the controller comprises an electronic processor having an electrical input for receiving the first data set in dependence on a route of the vehicle, and an electronic memory device electrically coupled to the electronic processor and having instructions stored therein, wherein the electronic processor is configured to access the memory device and execute the instructions stored therein such that it is operable to determine at least one payment option associated with the one or more toll stations; and output the at least one payment option to a display for selection by a user.

The first data set may comprise one or more monetary values associated with the one or more toll stations. For example, the first data set may include the fees associated with at least one vehicle class, that is, the fee due depending on the type of vehicle passing through the toll station.

The controller may be configured to calculate one or more fees in dependence on a number of the one or more toll stations located along the route of the vehicle. As such, if the vehicle is to pass through more than one toll station, the one or more payment options may include the fee for passing through all of the toll stations, and not just the fee for passing through the upcoming toll station. In some cases, the toll may vary in dependence on the time, day, or date, and this information may be used to improve the accuracy of the calculated total. Where a route is determined to pass through a number of toll stations, the controller may be arranged to calculate an approximate time of arrival at each toll station and then apply this information to the calculation.

The controller may be configured to receive a first user input selecting the at least one payment option.

The controller may be configured to output one or more method of payment options to the display in dependence on the first user input.

The one or more method of payment options may comprise at least one of: an option to pay automatically, and an option to pay manually at the one or more toll stations. In this respect, the user is provided with the option of paying manually at the toll station using cash or an electronic payment card, or to pay using an automatic payment system wherein the selected fee is debited from an associated account to thereby allow automatic passage through the toll station.

A route may cover a plurality of toll stations, some of which may have limited payment options, for example, there may be a number of toll stations on the route that only accept cash as a form of payment. Where such information is available, the controller may be arranged to notify the user of the available payment options, and if the user has input a preference to pay using automated electronic payment wherever possible, it may be indicative that the user does not habitually carry much, if any, cash with them. Thus, where toll stations are identified on the route that accept only cash payment, the controller may be arranged to notify the user of the location of and charges associated with these toll stations, and identify one or more ATM locations along the route to permit the user to obtain sufficient cash to pay for the tolls without significantly altering their journey or causing unnecessary delay.

The controller may be configured to receive a second user input selecting one of the one or more method of payment options.

The controller may be configured to: process the second data set in dependence on the received second user input; and allocate the toll station lane in dependence on the processing of the second data set. As such, depending on the method by which the driver or occupant wishes to pay, lane and/or traffic information will be used to allocate an appropriate lane. For example, if the driver or occupant intends to pay manually, a specific manual payment lane that has a low level of congestion will be allocated.

The allocated toll station lane may be output to the display when the vehicle is at a pre-determined distance from the first toll station. For example, the allocated toll station lane may be output to the display when the vehicle is between approximately 100 and 300 metres from the first toll station. Consequently, the driver is not distracted with deciding which lane they need to be in, and instead knows which lane to enter before they reach the toll station.

The controller may be configured to: receive a first user input indicating a first payment option and a second user input indicating a selection to pay automatically; transmit a request to deduct a first fee associated with the first payment option from a user account; and receive a first signal indicating a result of the request in dependence on a contents of the user account.

The first signal may comprise a confirmation that the first fee has been deducted from the user account.

The controller may be configured to transmit the first signal confirming payment of the first fee to the first toll station. In cases where the first fee corresponds to more than one toll station, for example, a second and third toll station, the controller may be configured to also transmit the first signal confirming payment of the first fee to the second and third toll stations.

The controller may be configured to output a signal to cause a barrier of the first toll station automatically open in response to the first signal confirming payment of the first fee. For example, the controller may be configured to communicate with the barrier of the toll station via a transponder installed on the vehicle such that, upon approaching the toll station, the barrier automatically opens to allow the vehicle through. As noted above, in cases where the first fee corresponds to more than one toll station, for example, a second and third toll station, the controller may also be configured send a signal to cause barriers of the second and third toll stations in response to the first signal confirming payment of the first fee. An advantage of automatically opening barriers based on advance payments is reducing queuing.

In other embodiments, the first signal may comprise an indication that the first fee has not been deducted from the user account. For example, the user account associated with the vehicle may not have sufficient funds for paying the first fee.

In such cases, the controller may be configured to re-allocate the toll station lane in response to the first signal, and output the re-allocated toll station lane to the display. For example, a manual payment lane may be allocated instead. In some embodiments, the user may be first provided with an option to add funds to the associated user account to enable automatic payment of the fee.

The controller may be configured to output the first signal to the display.

In some embodiments, if no user input is received selecting a payment option, the controller may be configured to automatically transmit a request to deduct the fee associated with the upcoming toll station. For example, if the user has not selected a payment option before the vehicle is about 500 metres from the upcoming toll station, the fee will be automatically paid via the user account.

The route of the vehicle may be a first route calculated in dependence on at least one geographical location. For example, the user may input a geographical location as the intended destination into a satellite navigation system, from which a route is calculated.

The controller may be configured to output the at least one payment option upon receiving data indicative of the route of the vehicle from a satellite navigation system in communication with the controller. For example, before departing, the user may input their destination to a satellite navigation system to calculate a route. The controller may then be configured to determine the at least one payment option and output it to the user upon receiving the route from the satellite navigation system. As such, the at least one payment option may output to the user whilst the vehicle is stationary, or at the beginning of the route.

The controller may be configured to output the at least one payment option when the vehicle is a predetermined distance from a toll station located along the route of the vehicle. As such, the at least one payment option may output to the user whilst the vehicle is travelling along the route. For example, the at least one payment option may be output to the display when the vehicle is about 1000 metres up to about 5000 metres from the first toll station. The predetermined distance may be dependent on a speed of the vehicle. An advantage is reducing driver distraction when the driver is temporally close to the toll station.

According to another aspect of the invention, there is provided a system for determining toll data, comprising: a display; and a controller as outlined above.

The display may comprise an in-vehicle display.

The system may comprise a satellite navigation system configured to calculate the route of the vehicle in dependence on at least one geographical location.

According to yet another aspect of the invention, there is provided a computer-implemented method for determining toll data, the method comprising: obtaining a first data set, wherein the first data set corresponds to one or more toll stations; obtaining a second data set indicating lane and/or traffic information associated with at least one of the toll stations; processing the first data set to determine at least one payment option associated with the one or more toll stations; outputting the at least one payment option to a human machine interface for selection by a user of a vehicle; locating a toll station lane of a first toll station, in dependence on the second data set; and outputting the allocated toll station lane to a human machine interface, to guide the user.

According to yet another aspect of the invention, there is provided a controller for determining toll data, the controller being arranged to: receive a data set indicating lane and/or traffic information associated with a first toll station; allocate a toll station lane of the first toll station, in dependence on the data set; and output the allocated toll station lane to a human machine interface to guide a user of a vehicle.

According to yet another aspect of the invention, there is provided a computer-implemented method for determining toll data, the method comprising: receiving a data set indicating lane and/or traffic information associated with a first toll station; allocating a toll station lane of the first toll station, in dependence on the data set; and outputting the allocated toll station lane to a human machine interface to guide a user of a vehicle.

According to yet another aspect of the invention, there is provided a controller for determining toll data, the controller being arranged to: receive a first data set in dependence on a route of a vehicle, wherein the first data set corresponds to one or more toll stations located along the route of the vehicle; process the first data set to determine at least one payment option associated with the one or more toll stations; and output the at least one payment option to a display for selection by a user.

According to yet another aspect of the invention, there is provided a computer-implemented method for determining toll data, the method comprising: obtaining a first data set in dependence on a route of a vehicle, wherein the first data set corresponds to one or more toll stations located along the route of the vehicle; processing the first data set to determine at least one payment option associated with the one or more toll stations; and outputting the at least one payment option to a display for selection by a user.

According to a further aspect of the invention, there is provided a computer readable medium comprising instructions that, when executed by a processor, causes the processor to perform one or more of the above methods. Optionally, the computer readable medium comprises a non-transitory computer readable medium.

According to a still further aspect of the invention, there is provided a vehicle, comprising a controller as outlined above, or comprising a system as outlined above, or configured to perform one or more of the methods as outlined above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic of a system for calculating and displaying toll information in accordance with an embodiment of the invention;

FIG. 2 is a schematic of a vehicle in accordance with an embodiment of the invention;

FIG. 3 is a flow diagram of a method for calculating and displaying toll information in accordance with an embodiment of the invention;

FIG. 4 is a flow diagram of a method for paying toll fees in accordance with an embodiment of the invention.

### DETAILED DESCRIPTION OF THE EMBODIMENTS

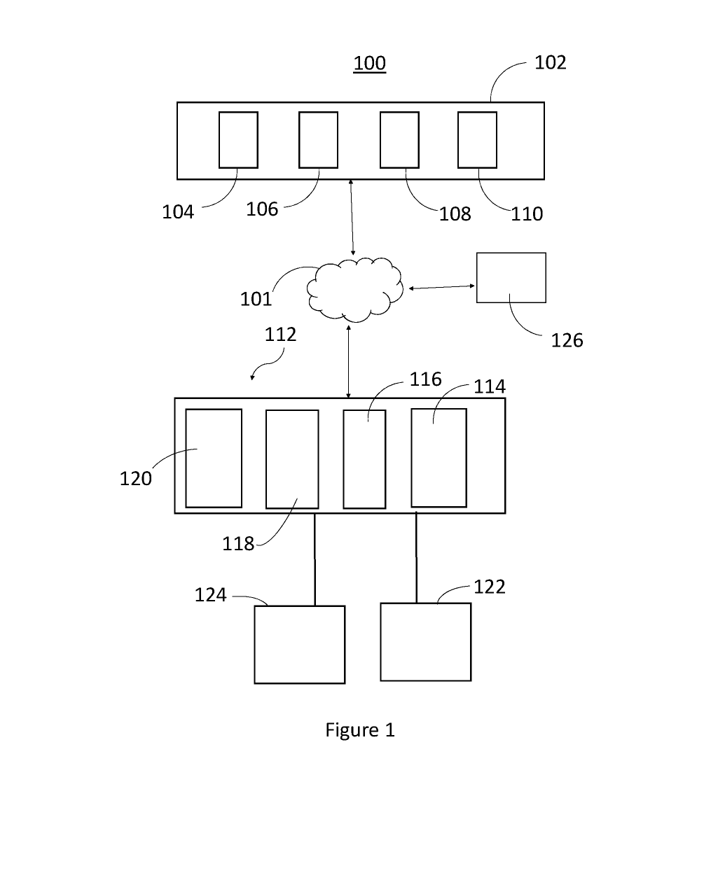

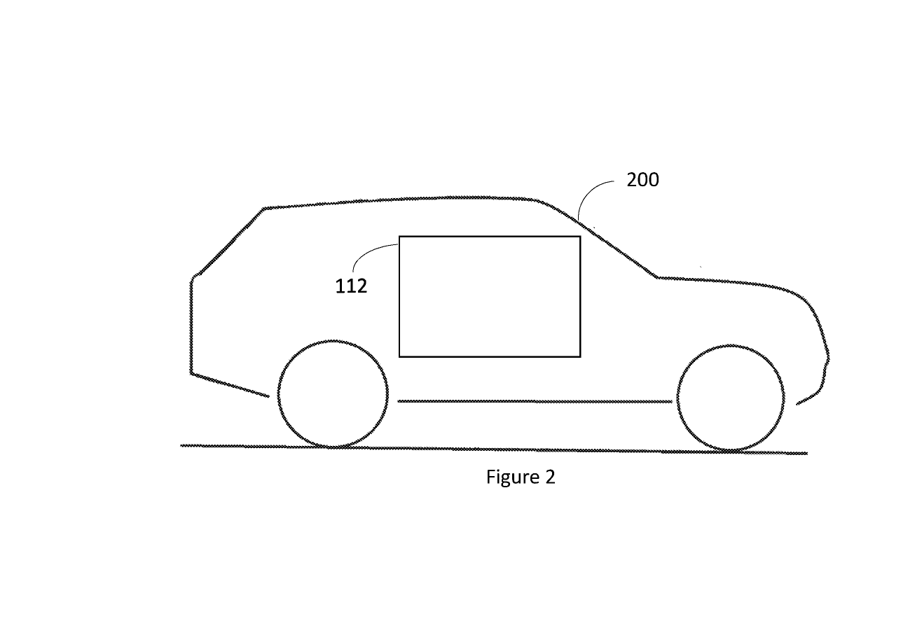

FIG. 1 is a schematic of a system 100 for determining and displaying toll information to a driver or occupant user of a vehicle. FIG. 2 shows a vehicle 200 comprising a part of the system 100, as will be described in more detail below. As shown in FIG. 2, the vehicle 200 is a car, however it will be appreciated that the present invention may be applied to a wide range of vehicles, including other road-going vehicles including vans, trucks, motorcycles, etc. along with other vehicles such as waterborne vehicles, for example.

The system 100 comprises a plurality of toll stations 104, 106, 108, 110 connected by a common toll station server 102. It will of course be appreciated however that individual toll stations 104, 106, 108, and 110 may be associated with separate servers. The system 100 also comprises a control means in the form of a computing device 112 in communication with the toll station server 102 via a wireless network 101 through a communications unit 116. The computing device 112 further comprises a processor 114, a computer readable medium 118 and a memory 120. The system 100 also comprises an input/output device 122 in communication with the computing device 112. In this respect, the input/output device 122 may be connected to the computing device 112 by wired or wireless means, the communication unit 116 being configured to allow wireless communication between the computing device 112 and the input/output device 122. The computing device 112 is configured to receive instructions from the input/output device 122, and output information to the input/output device 122. In this respect, the input/output device 122 comprises input means for receiving inputs from a user, and display means for displaying information to a user. The input/output device 122 may be a touchscreen. The touchscreen may be integral with the vehicle or may be part of a portable electronic device such as a smart phone.

In some embodiments, the input/output device 122 is a human machine interface (HMI) located inside the vehicle 200. However, in other embodiments, the input/output device 122 may be a device separate from the vehicle 200 such as a mobile phone, a personal computer or any other suitable device. It will also be appreciated that in some embodiments, the system 100 may comprise more than one input/output device 122, for example, a human machine interface (HMI) located inside the vehicle 200 and a remote device in the possession of the driver, passengers or other vehicle user.

Similarly, it will be appreciated that the computing device 112 itself may also be a remote device that is not part of the vehicle 200 itself, for example, a personal computer, a mobile phone or the like.

The system 100 also comprises a satellite navigation system 124 in communication with the computing device 112, connected by wired or wireless means. In this respect, the communications unit 116 may be further configured to allow wireless communication between the computing device 112 and the satellite navigation system 124. It will be appreciated that the satellite navigation system 124 may be a separate device, for example, a global navigation satellite system GNSS device attached to the dashboard of the vehicle 200, or integrated as part of the computing device 112. Whilst in this example, reference is made to GNSS, it will be appreciated that any suitable satellite navigation system may be used, such as GPS, GLONASS, Galileo or other suitable system, and the description herein is not intended to be limited to a single navigation system.

The processor 114 is configured to receive instructions from the input/output device 122 and the satellite navigation system 124. The processor 114 is further configured to retrieve data from the toll station server 102 and/or directly from the plurality of toll stations 104, 106, 108, 110 relating to the various fee options associated with each toll station 104, 106, 108, 110, and thereby determine one or more fee options for the driver or occupant in dependence on the route of the vehicle 200. In this respect, the satellite navigation system 124 is configured to calculate a route based on a geographical location or destination that has been input to the satellite navigation system by the user. The satellite navigation system 124 is also configured to track the vehicle 200 in real time such that it can predict the route of the vehicle 200. The processor 114 is then further configured to output the one or more fee options to the user via the input/output device 122 for display.

The system 100 also comprises a payment system 126 in communication with the computing device 112 and the toll station server 102 via the wireless network 101. The computing device 112 is configured to transmit requests to the payment system 126 for deduction of a toll fee from a user account. The payment system 126 is configured to carry out payment of the toll fee upon receiving requests from the computing device 112, and further configured to transmit information relating to the outcome of that payment back to the computing device 112 and toll station server 102, as will be described in more detail below.

As shown in FIG. 2, the vehicle 200 comprises the computing device 112. As described above, vehicle 200 may also comprise the input/output device 122 and the satellite navigation system 124. However, it will be appreciated that the computing device 112, input/output device 122, and satellite navigation system 124 may not be integrated in the vehicle 200, and may alternatively be one or more separate devices.

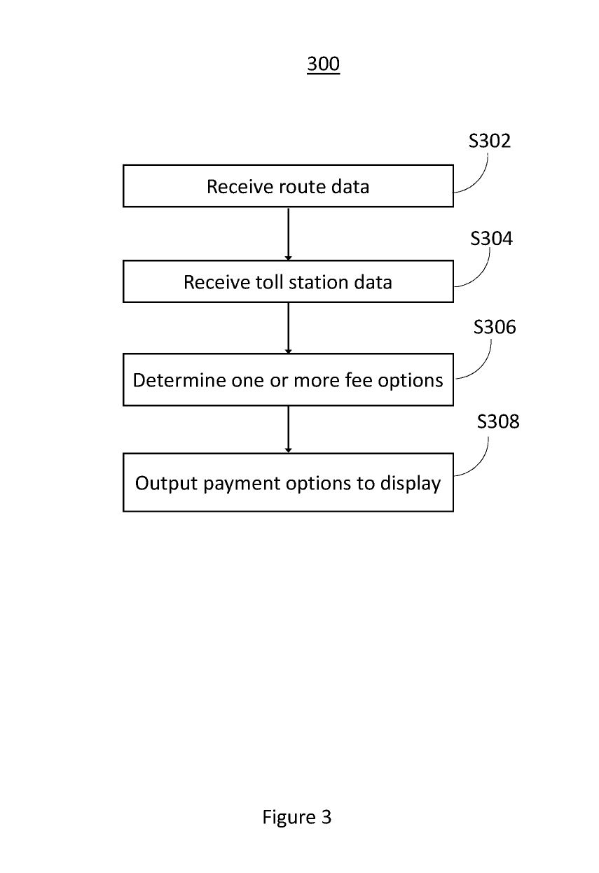

FIG. 3 shows a method 300 for determining and displaying toll information to a user.

The method begins at step S302 in which route data is received from the satellite navigation system 124. In some embodiments, the route data is based on a geographical location input by the user. As such, the user will input a geographical location as their target destination to the satellite navigation system 124, for example, via the input/output device 122, from which a route will be calculated. The geographical location input may be the location of a desired destination, or may comprise one or more waypoints en-route to a predetermined destination. Alternatively, the satellite navigation system 124 tracks the vehicle 200 in real-time to calculate an estimated route. For example, the vehicle 200 may be travelling along a highway, and so the satellite navigation system 124 will output route data on the basis that the vehicle 200 will continue along the highway. In some embodiments, the satellite navigation system 124 uses other user data such as calendar data and journey history to predict the route of the vehicle 200. For example, the computing device 112 may further configured to store calendar data corresponding to the driver or occupant user. If the calendar data indicates that the driver or occupant is scheduled to be at a meeting, then the satellite navigation system 124 will use the geographical location of the meeting to calculate a route. As another example, the satellite navigation system 124 may predict a route at a particular time and/or day if the vehicle 200 regularly takes that same route at that particular time and/or day.

Upon receiving this route data, the processor 114 will send a request to the toll station server 102 for information relating to any of the toll stations 104, 106, 108, 110, located along the route. For example, the route may include a first toll station 104 and a second toll station 106, and so the toll station server 102 will transmit the fee data associated with each of these two toll stations 104, 106 (S304). In this respect, the route data may include toll station identification numbers to enable the processor 114 to request the correct fee data from the toll station server 102. Alternatively, the fee data may be provided by the map database (not shown) with which the satellite navigation system 124 communicates. In this respect, the satellite navigation system 124 will retrieve information relating to the toll stations 104, 106, 108, 110 located along the route from the map database and output the information to the processor 114.

The fee data may include, for example, the fees associated with each vehicle class. Upon receiving the toll station data, the processor 114 will determine one or more fee options based on the toll station data (S306) for that vehicle 200. For example, the processor 114 may calculate the fee for passing through the first toll station 104 once, the fee for passing through both toll stations 104, 106 once, and the fee for passing through both toll stations 104, 106 twice (a return journey). To do this, the processor 114 may use data relating to the class of vehicle stored in the memory 120. The processor 114 will then output the determined payment options to the input/output device 122 for display (S308).

The user can then review all of the fee options available to them before they reach the first toll station 104 along the route. In this respect, the processor 114 may be configured to automatically output the payment options to the input/output device 122 as soon as route data has been received and the one or more fee options has been determined. For example, the payment options may be output to the input/output device 112 at the beginning of the journey, or before the journey has begun. Alternatively, the processor 114 may be configured to delay outputting the payment options until the vehicle 200 is at a particular distance from the first toll station 104. For example, the processor 114 may be configured to output the payment options when the vehicle 200 is between one and five kilometres from an upcoming toll station 104, 106, 108, 110. In this respect, the satellite navigation system 124 is configured to track the vehicle in real time and output the location of the vehicle 200 to the processor 114, in particular, the location of the vehicle with respect to the one or more toll stations 104, 106, 108, 110. The distance at which the processor 114 outputs the payment options may vary depending on the speed at which the vehicle is travelling. For example, if a car is travelling at 90 kilometres per hour, the processor 114 may output the payments options when the vehicle 200 is five kilometres from an upcoming toll station 104, 106, 108, 110 to give the driver or occupant sufficient time to review the payment options.

A route may cover a plurality of toll stations, some of which may have limited payment options, for example, there may be a number of toll stations on the route that only accept cash as a form of payment. Where such information is available, the processor 114 may be arranged to notify the user, via the input/output device 112, of the available payment options. If the user has input a preference to pay using automated electronic payment wherever possible, it may be indicative that the user does not habitually carry much, if any, cash with them. Thus, where toll stations are identified on the route that accept only cash payment, the processor 114 may be arranged to notify the user, via the input/output device 112, of the location of and charges associated with these toll stations, and additionally identify one or more ATM locations along the route to permit the user to obtain sufficient cash to pay for the tolls without significantly altering their journey or causing unnecessary delay.

In an example, not shown, the processor 114 is further provided with a signal from the vehicle 200 indicative of the vehicle occupancy. In some areas, the toll charge may vary depending on whether the vehicle passing the toll station is carrying a single occupant, such as a lone driver, or whether the vehicle has multiple occupancy, for example a driver and two passengers. The occupancy state of the vehicle may also dictate which lane on a multi-lane highway, the vehicle may use. Information pertaining to the vehicle occupancy may be used to provide the user with information as to the existence of a multiple-occupancy/car sharing lane on their route and adapt any directions as to which lane to approach a given toll station accordingly.

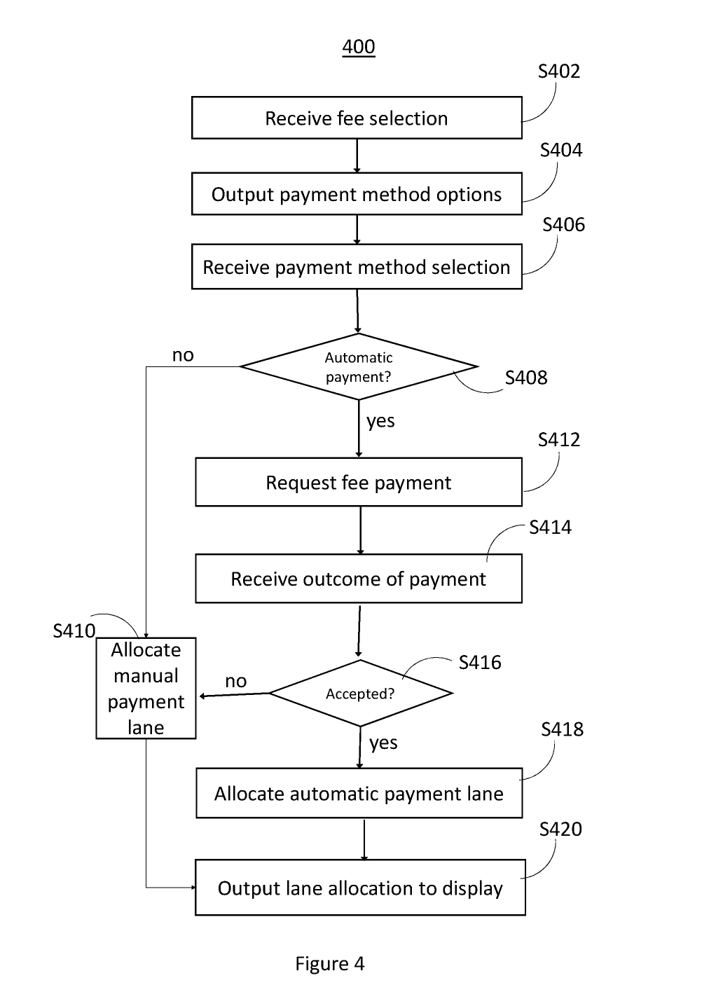

FIG. 4 shows a method 400 for paying the toll fees once the payment options have been determined and output to the input/output device 122, as described with respect to FIG. 3.

The method begins at step S402 in which the user selects one of the determined fee options via the input/output device 122. Using the above example, the user may select to pay the fee for passing through both toll stations 104, 106 one time in a single transaction. Upon receipt of the fee selection, the processor 114 is then configured to output one or more payment method options to the input/output device 122 (S404). For example, the processor 114 may output an option to pay manually, or to pay automatically using an associated user account. In some embodiments, the processor 114 will output the one or more payment method options when the vehicle 200 is at a particular distance from an upcoming toll station 104, 106, 108, 110. For example, the processor 114 may be configured to output the one or more payment method options when the vehicle 200 is between 300 and 500 metres from an upcoming toll station 104, 106, 108, 110. As before, the distance at which the one or more payment method options is output may vary depending on the speed at which the vehicle 200 is travelling.

The user may then select one of the payment method choices via the input/output device 122 (S406), which the processor 114 will analyse to determine how the fee is to be paid (S408).

If the fee is to be paid manually, the processor 114 will allocate a manual payment lane at the upcoming toll station 104, 106, 108, 110 (S410). To do this, the processor 114 will send a request to the toll station server 102 for lane and traffic information for the relevant toll stations 104, 106, 108, 110. Such lane and traffic information may include which lanes are manual payment lanes, which lanes are automatic payment lanes, and the length of queue at each of these lanes. Based on the lane and traffic information received, the processor 114 will determine which lane the vehicle 200 should use (S410) and output this lane allocation to the user via the input/output device 122 (S420). For example, the processor 114 may output a message indicating that the driver should use “lane 4” of the first toll station 104. In some embodiments, the processor 114 will determine the lane allocation and output the allocation to the input/output device 122 when the vehicle 200 is at a particular distance from the upcoming toll station 104, 106, 108, 110. For example, the processor 114 may be configured to output the lane allocation when the vehicle 200 is between 100 and 300 metres from an upcoming toll station 104, 106, 108, 110. As before, the distance at which the lane allocation is output may vary depending on the speed at which the vehicle 200 is travelling.

If the fee is to be paid automatically, that is, by deduction of the fee from an associated user account, the processor 114 will send a request to the payment system 126 to deduct the fee selected by the user (S412). The payment system 126 will then attempt to deduct the fee from the user account, and then transmit a message back to the processor 114 indicating the outcome of the transaction (S414), that is, whether or not the fee has been successfully deducted from the user account.

The processor 114 will analyse the message received from the payment system 126 (S416).

If payment has been successful, that is, the user account has sufficient funds for the fee to be deducted, the processor 114 will send a message to the toll station server 102 to indicate that the fee has been paid. Alternatively, the payment system 126 may be configured to send a confirmation message indicating that the fee has been deducted directly to the toll station server 102. The processor 114 will output a confirmation message to the driver or occupant via the input/output device 122 indicating that automatic payment has been successful.

Upon receiving confirmation that the payment has been accepted, the processor 114 will also send a request to the toll station server 102 for lane and traffic information for the relevant toll stations 104, 106, 108, 110, as described previously. Based on the received lane and traffic information, the processor 114 will determine which lane the vehicle 200 should use (S418) and output this lane allocation to the user via the input/output device 122 (S420). As noted above, in some embodiments, the processor 114 will determine the lane allocation and output the allocation to the input/output device 122 when the vehicle 200 is at a particular distance from the upcoming toll station 104, 106, 108, 110. For example, the processor 114 is configured to output the lane allocation when the vehicle 200 between 100 and 300 metres from an upcoming toll station 104, 106, 108, 110. As described above, where the occupancy of the vehicle 200 is known and the vehicle is driving on a highway with a multiple-occupancy or car-sharing lane, which is for use by vehicles travelling with multiple occupants on-board, the processor 114 may adapt the information presented via the input/output device 112 as to which lane to approach a given toll station, depending on whether the vehicle is travelling along a normal lane or a multiple-occupancy/car sharing lane.

In cases where the user has selected to pay for multiple toll stations 104, 106, 108, 110 automatically in a single transaction, the processor 114 will automatically perform the above lane allocation as the vehicle 200 approaches each toll station 104, 106, 108, 110. That is, a lane allocation will be output to the input/output device for toll stations 104, 106, 108, 110 that have already been paid for.

The vehicle 200 will then be able to pass straight through the toll station 104, 106, 108, 110, with the barrier being automatically lifted as the vehicle 200 approaches. In this respect, RFID or license plate recognition technology, as is known in the art, may be used to identify the vehicle 200 as it approaches the toll station 104, 106, 108, 110. For example, the computing device 112 may be in communication with a transponder fitted on the vehicle 200 that is configured to communicate with an antenna at the toll station 104, 106, 108, 110, wherein the transponder is associated with the user account. As the vehicle 200 approaches the toll station 104, 106, 108, 110, the antenna will pick up the transponder's unique signal and subsequently permit passage based on the information received from the computing device 112 or the payment system 126.

If the payment has not been successful, for example, due to insufficient funds, the processor 114 will send a request to the toll station 102 for lane and traffic information for the relevant toll stations 104, 106, 108, 110, and allocate a manual payment lane based on the received traffic information (S410), as described previously. In some embodiments, the processor 114 will also output a message to the input/output device 122 indicating that automatic payment was not successful, and may also provide the user with an option to replenish the funds in the user account prior to allocating a manual payment lane. If funds are added to the user account, then automatic payment may proceed as described above.

In some embodiments, if the user does not select a fee option, for example, before a particular distance from an upcoming toll station 104, 106, 108, 110, the processor 114 is configured to automatically send a request to the payment system 126 to deduct a single fee for that particular toll station 104, 106, 108, 110 from the user account. For example, the processor 114 may be configured to automatically send a request to the payment system 126 to deduct the fee from the user account if no fee selection has been made by the time the vehicle 200 is 500 metres from the toll station 104, 106, 108, 110.

In the above described embodiments, the selected fee is deducted from the user account prior to the vehicle approaching the toll station 104, 106, 108, 110. However, it will be appreciated that payment may be taken as the vehicle 200 approaches each toll station 104, 106, 108, 110. In such cases, at step S414, the payment system 126 will transmit a message to the processor 114 to confirm that payment will be taken at the barrier to enable the processor 114 to output a confirmation message to the driver or occupant via the input/output device 122, and to enable any lane allocation that is to be performed.

In some embodiments, the processor 114 is configured to retrieve balance information from the payment system 126, and subsequently output the balance information to the driver or occupant via the input/output device 122. This may be performed at any time, for example, after the selected fee has been deducted from the user account, after the vehicle 200 has passed through a toll station 104, 106, 108, 110, or when the vehicle 200 has reached its destination. The processor 114 may also be configured to output a notification to the input/output device 122 if the associated user account has a low or zero balance. This may be performed at any time, for example, after the processor 114 has received the route data and subsequently calculated the payment options determined.

In situations where the user account has insufficient funds to pay all of the toll fees on a given route, the processor 114 may be arranged to offer the user, via the input/output device 112, the choice to transfer funds into the user account, or present the user with the location of one or more ATM locations along the route to permit the user to obtain sufficient cash to pay for the tolls without significantly altering their journey or causing unnecessary delay.

In some embodiments, when the vehicle 200 reaches its destination, the processor 114 is configured to output the total amount spent on toll stations 104, 106, 108, 110 to the input/output device 122. For example, if the vehicle 200 has passed through two toll stations 104, 106 during its journey, the processor 114 will output the total cost spent passing through those two toll stations 104, 106 to the input/output device 122.

In some embodiments, the toll station lane may be allocated in dependence on one or more factors other than a user-selected method of payment associated with a subset of lanes.

For example, the toll station lane may be allocated in dependence on lane closure information associated with a subset of lanes. In an example implementation, the determination of an allocated toll station lane is constrained to lanes which are not closed. The above-described lane and traffic information may comprise lane closure information.

In a further example, the toll station lane may be allocated in dependence on traffic in one or more lanes relative to one or more other lanes. In an example implementation, a threshold function or cost function could be applied to a variable such as wait time or queue length associated with specific lanes. A lane with below-threshold traffic or a lower/lowest cost could be allocated. The above-described lane and traffic information may comprise this indication of relative traffic.

In a further example, the toll station lane may be allocated in dependence on a class of the vehicle 200. In an example implementation, a lorry may be allocated a first lane appropriate/designated for lorries and a car or motorcycle may be allocated a second lane appropriate/designated for non-lorries/cars/motorcycles.

Although various data as described herein could be obtained from a server, in some examples the data could be determined at the user's vehicle 200 via sensors of the vehicle 200 (e.g. traffic sign recognition), received via vehicle-to-vehicle communication, received via infrastructure-to-vehicle communication, or a combination thereof.

Although various data as described herein could represent a current state of a toll station 104, 106, 108, 110, the data could be predictive in some examples. Various data such as the number of toll station lanes, methods of payment, traffic, lane closures, vehicle class-specific lanes and vehicle occupancy-specific lanes could be determined via the sensors using object recognition/classification, and fed into a machine learning algorithm. The machine learning algorithm may generate predictive data for enabling methods as described herein to be performed for a later visit to the toll station 104, 106, 108, 110.

Although the data sets and other data as described herein could be dependent on a route of the vehicle 200, the data could be obtained without knowledge of a route of the vehicle 200. For example, the first data set could be received from a sensor of a vehicle 200 such as a camera, the output of which is interpreted by a traffic sign recognition algorithm. The traffic sign may reveal useful information for determining payment options, and even lane and traffic information if displayed on the traffic sign. Optionally, the vehicle 200 may only know that a toll station 104, 106, 108, 110 is being approached when a toll station traffic sign is detected. A route need not be programmed into a navigation system of the vehicle 200, although knowledge of a route would be beneficial for reducing false positive outputs.

In examples in which multiple toll stations are connected to each other or a central server 102, one or more shared parameters could be provided between toll stations to enable real time adaptation of toll station lane demarcations for changing conditions.

For example, the shared parameters could comprise method of payment statistics. If a first toll station encounters a high volume of traffic using a particular method of payment, other toll station(s) which that traffic may reach later could be provided with an indication of the method of payment statistics. This enables an automatic or manual change in the demarcation of lanes at other toll stations, for example to add additional lane(s) that accept the same method of payment. This could be performed in advance of the traffic from the first toll station reaching the other toll station(s). This reduces traffic queuing at the other toll station(s).

In a further example, the shared parameters could comprise traffic information. If a first toll station encounters a low volume of traffic, shared traffic information enables other toll stations to close several toll plazas to save energy that would otherwise be required for opening barriers, lighting, and over-plaza displays. If the volume of traffic is high, other toll stations could open several toll plazas to reduce queuing.

Other shared parameters could include vehicle occupancy, vehicle class, or any other parameter that can be used to change toll lane demarcations.

Data could be collected at a toll station and statistical analysis may be performed on the data automatically. A period for the statistical analysis could be a predetermined time period before a current time, e.g. last half hour. Upwards or downwards trends in the parameters could be used to determine the shared parameters. An upward trend in manual payments could result in an increased number of lanes assigned to a manual payment method.

Additionally or alternatively to sharing the parameters, a toll station could locally automatically or manually change its own lane demarcations in dependence thereof.

The above-described lane allocation process may adapt in dependence on the shared parameters, for example to enable newly opened lane(s) to be allocatable to specific vehicles. This further reduces traffic queuing at the other toll station(s).

Further aspects and preferred features of the invention will be apparent from the appended claims.

1. A controller for determining toll data, the controller being configured to:
receive a first data set, wherein the first data set corresponds to one or more toll stations;
receive a second data set indicating either or both lane and traffic information associated with at least one of the toll stations;
process the first data set to determine at least one payment option associated with the one or more toll stations;
output the at least one payment option to a human machine interface for selection by a user of a vehicle;
allocate a toll station lane of a first toll station based on the second data set; and
output the allocated toll station lane to a human machine interface to guide the user.

2. A controller according to claim 1, wherein the toll station lane is allocated based on at least one of the following:
a user-selected method of payment associated with a subset of lanes;
lane closure information associated with a subset of lanes;
a class of the vehicle;
an occupancy of the vehicle; and
traffic in one or more lanes relative to one or more other lanes.

3. A controller according to claim 1, wherein the first data set comprises one or more monetary values associated with each of the one or more toll stations.

4. A controller according to claim 3, the controller being further configured to calculate one or more fees based on a number of the one or more toll stations located along a route of the vehicle.

5. A controller according to claim 3, the controller being further configured to receive a first user input selecting the at least one payment option.

6. A controller according to claim 5, the controller being further configured to output one or more method of payment options to a human machine interface based on the first user input.

7. A controller according to claim 6, wherein the one or more method of payment options comprises at least one of the following: an option to pay automatically, and an option to pay manually at the one or more toll stations.

8. A controller according to claim 6, the controller being further configured to:
receive a second user input selecting one of the one or more method of payment options;
process the second data set based on the received second user input; and
allocate the toll station lane based on the processing of the second data set.

9. A controller according to claim 8, wherein the allocated toll station lane is output when the vehicle is at a pre-determined distance from the first toll station.

10. A controller according to claim 8, the controller being further configured to:
receive a first user input indicating a first payment option and a second user input indicating a selection to pay automatically;
transmit a request to deduct a first fee associated with the first payment option from a user account; and
receive a first signal indicating a result of the request based on contents of the user account.

11. A controller according to claim 10, wherein the first signal comprises either a confirmation that the first fee has been deducted from the user account or an indication that the first fee has not been deducted from the user account.

12. A controller according to claim 11, the controller being further configured to transmit the first signal confirming payment of the first fee to the first toll station.

13. A controller according to claim 12, the controller being further configured to output a signal to cause a barrier of the first toll station automatically open in response to the first signal confirming payment of the first fee.

14. A controller according to claim 10, the controller being further configured to:
re-allocate the toll station lane in response to the first signal indicating that the first fee has not been deducted from the user account; and
output the re-allocated toll station lane to a human machine interface.

15. A controller according to claim 1, wherein the first data set is dependent on at least one of the following:
a route of the vehicle, wherein the route of the vehicle is a first route calculated based on at least one geographical location;
a traffic sign recognition;
a vehicle-to-vehicle communication; or
an infrastructure-to-vehicle communication.

16. A controller according to claim 1, the controller being further configured to output the at least one payment option either or both upon receiving data indicative of a route of the vehicle from a satellite navigation system in communication with the controller and when the vehicle is a predetermined distance from a toll station located along a route of the vehicle.

17. A controller according to claim 16, wherein the predetermined distance is dependent on a speed of the vehicle.

18. A computer-implemented method for determining toll data, the method comprising:
obtaining a first data set, wherein the first data set corresponds to one or more toll stations;
obtaining a second data set indicating either or both lane and traffic information associated with at least one of the toll stations;
processing the first data set to determine at least one payment option associated with the one or more toll stations;
outputting the at least one payment option to a human machine interface for selection by a user of a vehicle;
allocating a toll station lane of a first toll station based on the second data set; and
outputting the allocated toll station lane to a human machine interface to guide the user.

19. A non-transitory computer readable medium storing a computer program comprising computer program instructions that, when performed by one or more processors, cause the one or more processors to perform the method of claim 18.

20. A vehicle comprising a controller according to claim 1.

21. A vehicle configured to perform a method according to claim 18.
